(19) United States
(12) Patent Application Publication
(10) Pub. No.: US 2014/0224340 A1
(43) Pub. Date: Aug. 14, 2014

(54) BUILDING WATER SAFETY DEVICE

(71) Applicants: Axel Klee, Rotenburg (DE); Klaus Klee, Rotenburg (DE); Ingmar Klee, Rotenburg (DE)

(72) Inventors: Axel Klee, Rotenburg (DE); Klaus Klee, Rotenburg (DE); Ingmar Klee, Rotenburg (DE)

(73) Assignee: PIPE SYSTEMS GMBH, Rotenburg (DE)

(21) Appl. No.: 14/345,923

(22) PCT Filed: Sep. 21, 2012
(86) PCT No.: PCT/EP2012/068692

§ 371 Date: Mar. 19, 2014

(30) Foreign Application Priority Data
Sep. 21, 2011 (DE) 20 2011 105 910.7

(51) Int. Cl. E03C 1/00; G05D 7/06

(52) U.S. Cl. CPC E03C 1/00; G05D 7/0623
USPC 137/1; 137/78.1

(57) ABSTRACT

Disclosed is a building water safety device, having a shut-off valve and a shut-off element, and having an actuator that is mechanically coupled to the shut-off element and moves the shut-off element between the open and closed positions. A sensor device for detecting the presence of a person in the area of a water removal point and a control device are provided, where the control device is operatively coupled to the sensor device and the actuator to open the shut-off element if a sensor signal signaling the presence of a person in the area of the water removal point is received from the sensor device and/or to close the shut-off element if a sensor signal signaling the absence of a person in the area of the water removal point is received from the sensor device.

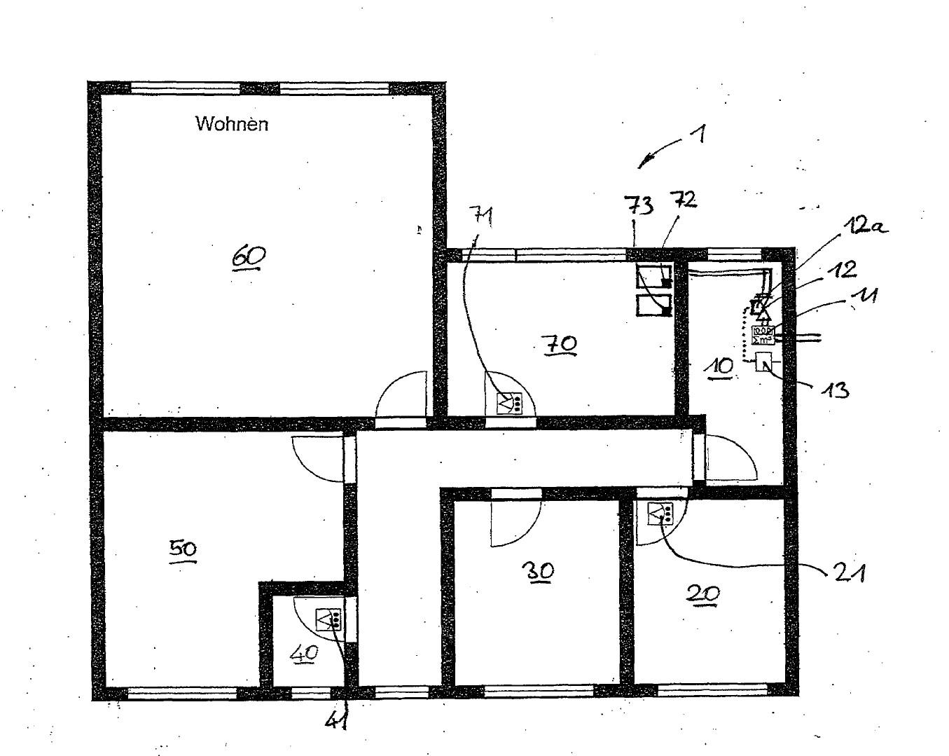

The invention relates to a building water safety device, comprising a shut-off valve having an inlet and an outlet opening, a valve channel, which connects the inlet opening to the outlet opening, and a shut-off device, which releases the valve channel for the passage of a medium from the inlet to the outlet opening when in an open position, and blocks said valve channel when in a closed position, an actuator, in particular an electromagnetically actuated actuator, which is mechanically coupled to the shut-off device, and which is designed to move the shut-off device from the open position into the closed position and vice versa.

Building water safety devices serve to prevent water damage in buildings. Various technologies for this purpose are already known. Thus, for example, it is known that an unwanted discharge of water can be detected by means of moisture sensors, which are installed in the floor area or in sinks, and an alarm can be activated in the event of such an unwanted discharge. Furthermore it is also known that flow restricting shut-off valves can be used in building water lines immediately before consumers, in order to prevent the discharge of water from a leak within the building having a larger volume flow.

It is in principle possible to prevent major damage as a result of water leaks within a building using the known measures; however, this cannot be guaranteed with sufficient reliability and often damages up to a certain size are accepted.

The object of the invention is to provide a safety device against water damage in buildings, which device can more reliably prevent the occurrence of damage as a result of leaks in building water lines.

This object is achieved according to the invention by means of a building water safety device of the design described at the beginning, which is characterized by a sensor device for detecting the presence of a person in the area of a water abstraction point, a control device that is coupled to the sensor device and the actuator by means of signals, which control device is designed to trigger the actuator to move the shut-off device into the open position when a sensor signal is received from the sensor device, which signals the presence of a person in the area of the water abstraction point, and/or to trigger the actuator to move the shut-off device into the closed position when a sensor signal is received from the sensor device, which signals the absence of a person in the area of the water abstraction point.

Along with the apparatus according to the invention, a special method of operation and functioning in building water systems is proposed. In particular, according to the invention, a shut-off valve is provided here, which may be disposed in the central water supply line of the building in order to cut off or release the water flow for the entire building. In particular, this shut-off valve may be placed downstream from the water meter of the central water supply line. The apparatus according to the invention makes it possible to keep this shut-off valve closed in principle most of the time, whereby no water will be discharged even if a leak occurs or other drop in water-tightness occurs in the building water supply network downstream of the shut-off valve.

In addition, the apparatus according to the invention provides a sensor device, which can detect whether persons are located in the area of a water abstraction point of the building. Here, a water abstraction point is understood to be any location at which water from the building water supply network can be used, thus for example a water tap, a toilet, a shower or bathtub, a water-consuming device such as a dishwasher or washing machine or the like. Here, the area of a water abstraction point is understood as a smaller or larger spatial area, which relates to access to a water abstraction point by a person. This may be the area immediately surrounding the water abstraction point itself, so that the sensor signal will only be triggered when a person immediately approaches the water tap, shower or the like. This may also be a larger spatial area, for example the entire room, such as a bathroom, the kitchen or the like, in which the water abstraction point is located. Likewise, this area may also only be the access area, which does not include the water abstraction point itself, but through which a person must pass in order to gain access to the water abstraction point.

Thus, according to the invention, when a person is located in this area, this will be signaled to the control device by means of the sensor device, and a signal will then be sent from the control device to the actuator of the shut-off valve, which causes an opening of the shut-off valve. This functional design always causes a selective opening of the central water supply line of the building when a water abstraction may be imminent. During all other periods of time, on the other hand, the shut-off valve can remain closed, thereby preventing an unwanted discharge of water. On the one hand, this function is effective in preventing water damage as a result of leaks, since line pressure to the entire building water supply network is invariably only applied for a short period of time and therefore a discharge of water due to a leak can only occur during such short periods of time. In addition, this function effectively prevents a permanent, accidental discharge of water from a water abstraction point, for example if someone forgets to completely shut off a water tap. In this case, when the person again leaves the area around the water abstraction point, the shut-off valve is then again shut off by an additional, elaborative function, whereby dripping of the water tap due to the tap being incompletely shut off is suppressed.

The apparatus according to the invention thus creates an effective reduction in the risk of water damage in the building, and of excessive water usage as a result of water abstraction points being insufficiently shut off.

In an alternative or additional configuration, the shut-off valve is actuated to go into a closed position when no person is detected in the area of a water abstraction point. This manner of functioning results in the immediate closing of the shut-off valve in the central water supply line as soon as water abstraction is no longer expected. On the one hand, this function can be combined with the opening of the shut-off valve when a person enters the area of a water abstraction point as described above, in order to thus control both the opening and closing process as a function of the sensor signal. If only the closing function is controlled as a function of the sensor signal, this may be combined with a current opening function, which is then only revoked or counteracted when the absence of a person is detected.

According to a first preferred embodiment, it is provided that the control device is designed to trigger the actuator to move the shut-off device into the closed position after a predetermined period of time after receiving a sensor signal from the sensor device, which signals the presence of a person in the area of the water abstraction point. According to this embodiment, the shut-off valve is compulsorily closed at the end of a predetermined period of time, in order to hereby ensure that the shut-off valve never remains open for an extended period of time. Here, the predetermined period of time may begin at the point in time at which a person was first detected in the area of the water abstraction point, or the absence of a person in the area of the water abstraction point may be processed as an ongoing event, and the period of time may begin at the point in time at which the person leaves the area.

In addition, it is preferably provided that the sensor device be designed to detect movement in the area of the water abstraction point and when such movement is detected, to signal to the control device the presence of a person in the area of the water abstraction point. This embodiment is characterized by the fact that movement is detected and therefore a differentiated approach is possible, in particular in the sensor configuration, for the presence or the entry of a person in the area of the water abstraction point. Thus, in particular, motion sensors of a known construction can be used for this embodiment. Furthermore it is to be understood that this embodiment can be combined with sensor devices that detect the presence of a person in the area of the water abstraction point, so that both movement and a static presence can be used as an input variable to open the shut-off valve.

Moreover, it is preferred that the sensor device operate actively by transmitting and receiving electromagnetic waves, actively by transmitting and receiving ultrasonic waves, or passively by receiving infrared radiation or a combination of two or all three of the above-mentioned modes of operation. With these sensor methods, it is possible to actively or passively monitor the area, respectively using the Doppler effect on the one hand, and the thermal radiation emitted by a person on the other. In order to ensure in particular that a sensor signal can only be triggered by a person entering the area, in particular combinations of different measuring methods can be used in order to prevent the accidental triggering of a sensor as a result of the movement of furnishings generated by a gust of wind, for example.

In addition, it is preferred that the sensor device and/or the actuator unit communicate wirelessly with the control device. Such wireless communication substantially facilitates the installation of the safety device according to the invention. Here, it is important to understand that, in particular, a plurality of sensor devices may be installed, and such that two or more sensor devices may be placed for a water abstraction point in order to monitor different access paths, but also a plurality of different water abstraction points can be monitored by a corresponding plurality of sensor devices, and likewise a plurality of water abstraction points may be jointly monitored by a single sensor device. In principle it is understood that these multiple sensor devices are able to communicate with one or more control devices. Similarly, it is understood that a single shut-off valve may be provided in the central water supply line of a building, and likewise that a plurality of shut-off valves may be disposed and controlled in decentralized lines of the building water supply network. In particular wireless networks, which are installed in the building for other communication purposes, for example WLAN networks, are especially suited for wireless communication.

In addition, it is preferred that the sensor device and/or the actuator unit have an energy store, preferably a rechargeable or replaceable energy store. In principle, both the sensor device and the actuator unit can be connected to the building's power supply grid in order to ensure the ongoing operation and corresponding supply of energy. In order to simplify installation, however, it is especially preferred for the sensor device to have an energy store, for example a replaceable battery, in order to enable easy and variable installation and positioning. Here, it is understood that this embodiment having an energy store is especially advantageous when wireless communication is also simultaneously provided, so that the sensor device can be positioned and installed entirely free of power and energy supply cables.

In addition, it is preferred that the shut-off valve be integrated into the central water supply line of a building and that a sensor device be provided in each area of one or more water abstraction point(s) of the building. On the one hand, such a configuration reliably prevents the unwanted discharge of water as a result of leaks or the incomplete shut-off of water abstraction points and, on the other hand, makes it possible for a person or a water-consuming device, respectively, to abstract water at every water abstraction point in the building by monitoring the area of these water abstraction points by means of the sensor device.

In addition, it is preferred that the control device be part of a building management system and preferably communicate with the sensor devices and/or the actuator within the building by means of a wireless network. With this specific configuration, an existing network can be used to control the safety device and, if necessary, to store switching operations that occur according to time, triggering location, duration and, if applicable, additional parameters. In so doing, an in-house WLAN network may be used, for example. Likewise, an installed home control unit, which already performs other functions, such as heating control, ventilation control, shutter control, light control or the like, could be implemented as a control device. Likewise, it is alternatively possible to allow the control function of the control device according to the invention to be implemented by means of a run installed in-house wireless network computer having the appropriate software.

According to an additional preferred embodiment, it is provided that the safety device according to the invention be embodied by a switching device, which is coupled with the control device by means of signals, and which is designed to detect a start-up actuation of a water-consuming device and to transmit a signal to the control device to open the shut-off valve. In this case in particular, a water-consuming device may be understood to be a dishwasher or washing machine, which is characterized in that, once turned on by a person, said devices run for a predetermined period of time, which may be longer or shorter depending on the type of program, and in so doing, consume water on an ongoing basis or at intervals. In this case, in order to ensure the functioning of such a water-consuming device in conjunction with the invention, it is not sufficient that the shut-off valve only be open for the period of time in which a person is located in the area of this device. Rather, it is necessary to ensure that the shut-off valve is open throughout the entire period of time during which the water-consuming device is running. This may be achieved either by using a fixed time control, during which the shut-off valve remains open for a predetermined period of time either after the device has been switched on or after a person has been detected in the area of the device by a sensor, which predetermined period of time exactly corresponds to or exceeds the maximum run time of the device. In additional advanced embodiments, the shut-off valve may remain open for precisely the duration of the run time of the device. In this case, intelligent communication between the control device according to the invention and the water-consuming device is required in order to communicate the program run time or to process the power consumption of the device accordingly. For this purpose, the water-consuming device or its power supply may communicate with the controller of the safety device according to the invention by means of an appropriate interface. In particular, appropriate interface modules therefor may already be provided, which are connected to the water consuming device.

Moreover, it is preferred when the switching device comprises a sensor, which is designed to detect the switching status or a switching process of an electromagnetic peripheral shut-off valve, in particular in that the sensor comprises an electric coil or an electronic magnetic field sensor, which is designed to detect a magnetic field of an electromagnet of the peripheral shut-off valve, or comprises a microphone to detect a switching noise or a flow noise of the peripheral shut-off valve, and that the start-up actuation is detected by means of an opening process of the peripheral shut-off valve. This further embodiment makes it possible to very precisely determine the point in time at which a water-consuming device requests water, or conversely, to very precisely determine the point in time at which a water-consuming device no longer needs water, and to control the shut-off valve accordingly. To this end, the apparatus according to the invention is equipped with a sensor, which may be attached, for example bonded, to a peripheral shut-off valve, which is frequently referred to as an aquastop valve, by means of a brace or the like. This sensor detects a switching process or the switching status of this peripheral shut-off valve and can thereby determine whether the water-consuming device connected to this peripheral shut-off valve needs water or not. The sensor signal is transmitted either through a wireless or wired connection, for example by means of a cable or with the assistance of a signal voltage or a cable having a constant current source, as a condition of switch contacts to control other devices, as an infrared signal, as an electromagnetic RF signal, as an ultrasonic signal or as an acoustic signal. In so doing, it is also preferred that an amplifier, a low-pass filter and/or rectifier be provided for the sensor signal in order to appropriately amplify, low-pass filter and rectify the signal, and in this way, obtain a clear, defect-free signal.

According to yet another preferred embodiment, it is provided that the safety device according to the invention is further embodied by a flow measurement device or a pressure measurement system for detecting flow or pressure in a central water supply line, and characterized in that the control device is designed to carry out a test of the water supply network at a predetermined point in time when no person is detected in the area of a water abstraction point and, as the circumstances may require, no water-consuming device is activated, with said test of the water supply network including the following steps: Opening of the shut-off valve by means of the actuator, and detection of flow by means of the flow measurement device or detection of the pressure characteristic when the shut-off valve is closed for a predetermined period of time by means of the pressure measurement system, display of water leaks in the event that flow or a drop in pressure is detected and, as the circumstances require, closing of the shut-off valve by means of the actuator.

This further embodiment makes it possible to test the water-tightness of the entire building water supply network on a regular basis or when initiated by a user request. A basic precondition for this is that this test be carried out at a point in time at which no water is being abstracted at a water abstraction point in the building. If a test is performed at a regularly programmed point in time, a testing time during the night can preferably be chosen for this purpose, for example between two and four a.m., since experience shows that there is the highest likelihood that no water will be used at a water abstraction point during this period of time.

According to the invention, detection of whether there is flow through the shut-off valve is then performed by means of a flow measurement device when the shut-off valve is open. The detection of such a flow would give a clear indication of the existence of a leak or an incompletely closed water abstraction point within the building. In this case, the safety device according to the invention could emit a corresponding acoustic or visual signal to indicate this determination, and moreover, as already regularly provided, would close the shut-off valve when the test has been successfully performed in order to prevent the further unwanted discharge of water. Alternatively or in addition to this, a pressure measurement system may be installed in the area downstream from the shut-off valve, which system detects the pressure downstream from the shut-off valve. In this case, the shut-off valve can be closed and the behavior of the water pressure in the water supply line downstream from the shut-off valve can be detected by means of the pressure measurement system for a predetermined period of time from an operating position, in which the shut-off valve is opened, however, in which all water abstraction points in the building are closed or at least a substantial throttling effect is exerted. If, in so doing, the control device according to the invention determines that this pressure remains constant or is only dropping at a low, predetermined rate, this indicates that the water supply network within the building is, in this respect, water-tight. A drop in pressure or significant drops in pressure that are observed by the control device, on the other hand, indicate the discharge of water from the water supply network downstream from the shut-off valve, and thus could be signaled by means of an acoustic or visual signal. The advantage of this last embodiment is that, in order to test the water-tightness of the water supply network, the shut-off valve does not have to be opened and consequently water will not be applied to any existing leaks during the test.

A further aspect of the invention is a method of preventing water damage in buildings having the following steps: Shutting off a central water supply line by means of an actuator operated shut-off valve, detecting persons in the area of a water abstraction point in the building by means of a sensor device, in particular a motion detector, controlling the actuator of the shut-off valve to open the shut-off valve when a person is detected in the area of a water abstraction point in the building.

The method can be further embodied by means of the steps of detecting a start-up actuation on a water-consuming device, controlling the actuator of the shut-off valve to open the shut-off valve, when a start-up actuation is detected.

In addition, the method can be further embodied with the following steps: Wireless transmission of a signal from the sensor device and/or the water-consuming device to a control device, and/or wireless transmission of a signal from the control device to the actuator of the shut-off valve.

In addition, the method can be further embodied with the following steps: Detection of the switching status or a switching process of an electromagnetic peripheral shut-off valve of the water-consuming device, in particular by means of a direct readout of a control signal of a peripheral shut-off valve or inductive scanning by a coil disposed in the area of the peripheral shut-off valve or a magnetic field sensor disposed in the area of the peripheral shut-off valve, or acoustic scanning of a switching sound of the peripheral shut-off valve and controlling the actuator of the shut-off valve as a function of the switching status or switching process of the peripheral shut-off valve.

Finally, the method can be further embodied with the steps that a test for leaks is carried out at a predetermined testing time at regular intervals, or when a testing button is actuated. This can be done, for example, by means of the following steps: Opening of the shut-off valve by means of the actuator, and detecting flow by means of a flow measurement device; or this can be done by means of the following step: Recording a pressure characteristic for a predetermined period of time by means of a pressure measurement system when the shut-off valve is closed downstream from the shut-off valve in the direction of flow. If flow or a drop in pressure is detected, in both cases a water leak is signaled by means of a visual or acoustic signal, whereby in the case of the first measuring method, the shut-off valve must additionally be closed in order to prevent the further discharge of water.

The invention is characterized by the use of a motion detector or a similar sensor device for securing a building water supply network, in which a shut-off valve is controlled on the basis of a detected movement. The invention is further characterized by the use of a shut-off valve to secure a building water supply network, in which this valve is actuator operated under the control of a motion detector.

A preferred embodiment of the invention is described with reference to the accompanying Figures, which show a schematic floor plan of a building, which is equipped with the safety device according to the invention.

A building 1 is shown in the depicted floor plan, which comprises a utility room 10, which has a connection to the public water supply network. This connection first leads to a water meter 11, whereby a safety valve 12 is disposed downstream from this water meter 11 in the direction of flow.

An electronic control unit 13 is likewise disposed in the utility room, which unit communicates via a wireless connection with a plurality of motion detectors, which will be described below. The control unit 13 is coupled to an actuator 12a via a wireless connection, which actuator is able to actuate the safety valve from an open position into a closed position and vice versa.

The building further comprises a bathroom 20, a children's room 30, a guest bathroom 40, a bedroom 50, a living room 60 and a kitchen 70. A motion detector 21, 41, 71 is disposed in the area of each door that leads from a corridor 80 into the bathroom 20, the guest bathroom 40 and the kitchen 70, respectively. This motion detector detects the entry of a person into the respective room and the presence of a person in the respective room.

Each motion detector 21, 41, 71 communicates via a wireless connection with the electronic control unit 13 in the utility room, and signals the entry or presence of a person in the respective room that is being monitored. If such a message is received from the electronic control unit 13, that unit triggers the actuator 12a, in order to open the safety valve 12.

In so doing, the electronic control unit is programmed in such a way that it receives the message that someone is present from the motion detector 21 and 41 and keeps the safety valve open for as long as the person remains in the respective room, and promptly closes the safety valve as soon as the motion detector no longer signals the presence of a person in the bathroom 20 or guest bathroom 40.

If the motion detector 71 signals the presence of a person in the kitchen 70, the control unit continues to query the communicating electronic modules 72, 73 via a wireless connection, which signal the actuation of a dishwasher and a washing machine. If these electronic modules 72, 73 signal to the electronic control unit that one or both devices are running, the electronic control unit will keep the safety valve open for the duration of time in which these are running, and will only close these once the dish-washing or clothes-washing process is complete.

Alternatively or in addition to the direct query by the electronic modules 72, 73, an aquastop valve, which is used in the water supply line to the dishwasher or washing machine, is scanned by means of a sensor. The sensor comprises a magnetic field sensor, which detects the actuation of the electromagnets of the aquastop valve, and transmits this to the control unit as a signal by means of a radio transmission. The signal is amplified, deep-pass filtered and rectified to a control signal in order to control the shut-off valve.

1-32. (canceled)

33. A building water safety device, comprising:
a shut-off valve having an inlet and outlet opening, a valve channel, which connects the inlet opening to the outlet opening, and a shut-off device, which releases the valve channel for the passage of a medium from the inlet to the outlet opening when in an open position, and blocks said valve channel when in a closed position,
an actuator, in particular an electromagnetically actuated actuator, which is mechanically coupled to the shut-off device, and which is designed to move the shut-off device from the open position into the closed position and vice versa,
a sensor device for detecting the presence of a person in the area of a water abstraction point,
a control device that is coupled to the sensor device and the actuator by means of signals, which control device is designed to:
trigger the actuator to move the shut-off device into the open position when a sensor signal is received from the sensor device, which signals the presence of a person in the area of the water abstraction point, and/or
to trigger the actuator to move the shut-off device into the closed position when a sensor signal is received from the sensor device, which signals the absence of a person in the area of the water abstraction point,
wherein the control device comprises a sensor, which is designed to detect the switching status or a switching operation of an electromagnetic peripheral shut-off valve, and that the start-up actuation is detected by means of an opening process of the peripheral shut-off valve.

34. The building water safety device according to claim 33, wherein the switching status or the switching operation is detected by the sensor,
comprising an electric coil or an electronic magnetic field sensor, which is designed to detect a magnetic field of an electromagnet of the peripheral shut-off valve, or
comprising a microphone for detecting a switching noise or flow noise of the peripheral shut-off valve.

35. The building water safety device according to claim 33, wherein the control device is designed to trigger the actuator to move the shut-off device into the closed position after a predetermined period of time after receiving a sensor signal from the sensor device, which signals the presence of a person in the area of the water abstraction point.

36. The building water safety device according to claim 33, wherein the sensor device is designed to detect movement in the area of the water abstraction point and, when such movement is detected, to signal to the control device the presence of a person in the area of the water abstraction point.

37. The building water safety device according claim 33, wherein the sensor device is designed to detect a local change in the area of the water abstraction point, and when such a local change in temperature is detected, to signal to the control device the presence of a person in the area of the water abstraction point.

38. The building water safety device according to claim 33, wherein the sensor device
operates actively, by transmitting and receiving electromagnetic waves,
operates actively, by transmitting and receiving ultrasonic waves, or
operates passively by receiving infrared radiation,
or a combination of two or all of the above mentioned modes of operation.

39. The building water safety device according to claim 33, wherein the sensor device and/or the actuator unit communicates with the control device by means of a wireless connection.

40. The building water safety device according to claim 33, wherein the sensor device and/or the actuator unit has an energy store, preferably a rechargeable or replaceable energy store.

41. The building water safety device according to claim 33, wherein the shut-off valve is integrated in the central water supply line of a building, and in that a sensor device is provided in each area of one or more water abstraction point(s) of the building.

42. The building water safety device according to claim 33, wherein the control device is part of a building management system and preferably communicates with the sensor devices and/or the actuator within the building by means of a wireless network.

43. The building water safety device according to claim 33, comprising a switching device, which is coupled to the control device by means of signals, and is designed to detect a start-up actuation of a water-consuming device, and to transmit a signal to the control device to open the shut-off valve.

44. The building water safety device according to claim 33, comprising a flow measurement device or a pressure measurement system for detecting flow or pressure in a central water supply line, and wherein the control device is designed to carry out a test of the water supply network at a predetermined point in time or within a predetermined period of time, when no person is detected in the area of a water abstraction point and when no water-consuming device is activated, as the circumstances may require, with said test comprising the following steps:
opening of the shut-off valve by means of the actuator, and the detection of flow by means of the flow measurement device, or
detection of the pressure characteristic over a predetermined period of time by means of the pressure measurement system when the shut-off valve is closed,
display of water leakage in the event that flow or a drop in pressure is detected and,
as the circumstances may require, closing the shut-off valve by means of the actuator.

45. A method for preventing water damage in buildings, including the following steps:
shutting off a central water supply line by means of an actuator operated shut-off valve,
- detection of persons in the area of a water abstraction point in the building by means of a sensor device, in particular a motion detector,
controlling the actuator of the shut-off valve to open the shut-off valve, when a person is detected in the area of a water abstraction point in the building, characterized by the following steps:
a) detection of the switching status or a switching process of an electromagnetic peripheral shut-off valve of the water-consuming device, and
b) control of the actuator of the shut-off valve as a function of the switching status or switching process of the peripheral shut-off valve.

46. The method according to claim 45, wherein the switching status or the switching operation is detected via a
direct readout of a control signal of the peripheral shut-off valve,
shut-off valve, or by means of a magnetic field sensor, which is disposed in the area of the peripheral shut-off valve, or
acoustic scanning of a switching noise of the peripheral shut-off valve.

47. The method according to claim 45, including the following steps:
detecting start-up actuation on a water-consuming device,
controlling the actuator of the shut-off valve to open the shut-off valve when a start-up actuation is detected.

48. The method according to claim 45, including the following steps:
wireless transmission of a signal from the sensor device and/or the water-consuming device to a control device, and/or
wireless transmission of a signal from the control device to the actuator of the shut-off valve.

49. The method according to claim 45, including the following steps:
at a predetermined testing time at regular time intervals, or when a testing button is actuated:
opening of the shut-off valve by means of the actuator, and
detection of the flow by means of a flow measurement device, or
detection of a pressure characteristic over a predetermined period of time with a closed shut-off valve by means of a pressure measurement system downstream from the shut-off valve in the direction of flow, and
closing the shut-off valve by means of the actuator and displaying water leakage in the event that a flow or a drop in pressure is detected.
